(19) United States
(12) Patent Application Publication
(10) Pub. No.: US 2026/0067200 A1
(43) Pub. Date: Mar. 5, 2026

(54) SYSTEMS AND METHODS FOR DISTRIBUTED TRAFFIC ENGINEERING IN A COMMUNICATION NETWORK

(71) Applicant: The MITRE Corporation, McLean, VA (US)

(72) Inventors: Ing-Wher CHEN, McLean, VA (US); Venkatesh RAMASWAMY, Westford, MA (US)

(73) Assignee: The MITRE Corporation, McLean, VA (US)

(21) Appl. No.: 18/820,484

(22) Filed: Aug. 30, 2024

(51) Int. Cl. H04L 45/12; H04L 45/02

(52) U.S. Cl. CPC H04L 45/123; H04L 45/02

(57) ABSTRACT

A communication network router comprises one or more processors and memory storing one or more programs for execution by the one or more processors, the one or more programs including instructions that cause the communication network router to: receive a first message from a first router of a plurality of routers of a communication network, the first message comprising a first algorithm identifier associated with a first link cost computation algorithm and a first set of local condition data corresponding to the first router; compute, based on the first set of local condition data, a first set of link costs using the first link cost computation algorithm; compute, based on the first set of link costs, a first set of loop-free paths through the communication network; and route at least one communication according to the first set of loop-free paths.

### GOVERNMENT SUPPORT

This invention was made with government support under FA8702-19-C-0001 awarded by the United States Air Force and W56KGU-18-D-0004 awarded by the Army Contracting Command. The government has certain rights in the invention.

### FIELD

The present disclosure relates generally to communications networks, and more specifically to systems and methods for distributed traffic engineering in a communication network.

### BACKGROUND

Conventional communication network traffic engineering architectures include a centralized controller that provides information or instructions to routers on how to route communications through the network. The centralized controller calculates link costs for the entire communication network and provides the link costs to the individual routers. Using the link costs provided by the centralized controller, the individual routers can calculate routing tables. Routing tables are data structures that list, for a given router, next hop routers (e.g., adjacent routers) that the router can use to route communications to various network destinations. Calculating link costs at a centralized controller and distributing the link costs to each router in the communication network can generate a large amount of network traffic and worsen the latency of the network.

### SUMMARY

Described herein are improved systems and methods for routing communications in a communication network in which link costs for traffic engineering are computed at routers in a distributed manner. The systems and methods described herein enable individual routers to calculate link costs themselves, eliminating the need for a centralized controller to communicate link costs to the routers. Eliminating the need for a centralized controller to communicate link costs can reduce the amount of network traffic and the latency of the network. Routers may transmit messages to one another that include local condition information and an algorithm identifier associated with a link cost computation algorithm. A given router can use the local condition information received from other routers to compute link costs using the identified link cost computation algorithm. Alternatively, a given router may predict link costs using a machine learning model trained via federated learning or gossip learning, which may reduce or eliminate the need for routers to exchange local condition information that may be excessive or sensitive. The link costs computed by the router may then be used to calculate loop-free paths, which may in turn be used to route communications through the network.

An exemplary router may be part of a communication network, such as an internet protocol computer network. The router may be configured to receive a message from a first router of a plurality of routers in the network. The message may include a set of local condition data about the first router from which the message was sent. The local condition data may include information about the traffic transiting the first router (e.g., the rate of traffic and the source and destination IP addresses of the traffic transiting the first router). The message may also identify an algorithm identifier associated with a link cost computation algorithm. The link cost computation algorithm associated with the algorithm identifier may be used to calculate link costs, which indicate the desirability of a link. Alternatively, or additionally, the message may include one or more machine learning models and/or parameters thereof, and the one or more machine learning models may be used to predict link costs. The algorithm identifier and the set of local condition data (and/or the machine learning models) may be incorporated into existing messaging exchanged between routers in the network. Based on the set of local condition data, the router may use the link cost computation algorithm associated with the algorithm identifier to compute a set of link costs for the communication network. Alternatively, the router may use the one or more machine learning models to predict a set of link costs for the communication network. Based on the link costs, the communication network router may compute a set of loop-free paths through the communication network. A communication may then be routed through the network according to the set of loop-free paths.

An exemplary communication network router includes one or more processors and memory storing one or more programs for execution by the one or more processors, the one or more programs including instructions that cause the communication network router to: receive a first message from a first router of a plurality of routers of a communication network, the first message comprising a first algorithm identifier associated with a first link cost computation algorithm and a first set of local condition data corresponding to the first router; compute, based on the first set of local condition data, a first set of link costs using the first link cost computation algorithm; compute, based on the first set of link costs, a first set of loop-free paths through the communication network; and route at least one communication according to the first set of loop-free paths.

The first algorithm identifier may be associated with a path computation algorithm. The first set of loop-free paths may be computed using the path computation algorithm. The path computation algorithm may be a shortest path algorithm or a minimum spanning tree algorithm. The first message may include at least a second set of local condition data corresponding to at least a second router. The instructions may cause the communication network router to update a routing table based on the first set of loop-free paths. Routing at least one communication according to the first set of loop-free paths may include: receiving the at least one communication from a first edge device; determining, based on at least the first set of loop-free paths, a path through the communication network between the first edge device and a second edge device; and transmitting the at least one communication along the determined path.

A second link cost computation algorithm may be stored in the memory of the communication network router. The communication network router may be configured to: receive a second message from the first router comprising a second algorithm identifier associated with the second link cost computation algorithm and a second set of local condition data corresponding to the first router; compute, based on the second set of local condition data, a second set of link costs using the second link cost computation algorithm; compute, based on the second set of link costs, a second set of loop-free paths through the communication network; and route at least one communication according to the second set of loop-free paths.

The first link cost computation algorithm may be prioritized Dynamic Routing Control Agent (pDRCA), a Multi-Agent Reinforcement Learning (MARL) algorithm, an Open Shortest Path First (OSPF) algorithm, or an Intermediate System to Intermediate System (IS-IS) algorithm. The first set of local condition data corresponding to the first router may include an amount of traffic transiting the first router and source and destination IP addresses of traffic transiting the first router. The first set of local condition data may include encrypted local condition data. The first message may include a locally-trained machine learning model or parameters of the locally-trained machine learning model, wherein the locally-trained machine learning model is configured to predict link costs. The communication network router may be a wired router, a wireless router, an edge router, a core router, a physical router, or a virtual router. The first algorithm identifier may correspond to an entry in a registry including a plurality of algorithm identifiers, wherein each algorithm identifier of the plurality of algorithm identifiers is associated with at least one respective algorithm. The registry may be stored in a memory of the communication network router. The registry may be stored remotely and accessed by the communication network router.

An exemplary method for routing communications in a network includes: at a communication network router: receiving a first message from a first router of a plurality of routers comprising a first algorithm identifier associated with a first link cost computation algorithm and a first set of local condition data corresponding to the first router; computing, based on the first set of local condition data, a first set of link costs using the first link cost computation algorithm; computing, based on the first set of link costs, a first set of loop-free paths through the communication network; and routing at least one communication according to the first set of loop-free paths.

The first algorithm identifier may be associated with a path computation algorithm. Computing the first set of loop-free paths may include applying the path computation algorithm. The path computation algorithm may be a shortest path algorithm or a minimum spanning tree algorithm. The first message may further include at least a second set of local condition data corresponding to at least a second router. The method may include updating a routing table based on the first set of loop-free paths. Routing at least one communication according to the first set of loop-free paths may include: receiving the at least one communication from a first edge device; determining, based on at least the first set of loop-free paths, a path through the communication network between the first edge device and a second edge device; and transmitting the at least one communication along the determined path.

A second link cost computation algorithm may be stored in a memory of the communication network router. The method may further include: receiving a second message from the first router comprising a second algorithm identifier associated with the second link cost computation algorithm and a second set of local condition data corresponding to the first router; computing, based on the second set of local condition data, a second set of link costs using the second link cost computation algorithm; computing, based on the second set of link costs, a second set of loop-free paths through the communication network; and routing at least one communication according to the second set of loop-free paths.

The first link cost computation algorithm may be prioritized Dynamic Routing Control Agent (pDRCA), a Multi-Agent Reinforcement Learning (MARL) algorithm, an Open Shortest Path First (OSPF) algorithm, or an Intermediate System to Intermediate System (IS-IS) algorithm. The first set of local condition data corresponding to the first router may include an amount of traffic transiting the first router and source and destination IP addresses of traffic transiting the first router. The first set of local condition data may include encrypted local condition data. The first message may include a locally-trained machine learning model or parameters of the locally-trained machine learning model, wherein the locally-trained machine learning model is configured to predict link costs. The communication network router may be a wired router, a wireless router, an edge router, a core router, a physical router, or a virtual router. The first algorithm identifier may correspond to an entry in a registry including a plurality of algorithm identifiers, wherein each algorithm identifier of the plurality of algorithm identifiers is associated with at least one respective algorithm. The registry may be stored in a memory of the communication network router. The registry may be stored remotely and accessed by the communication network router.

An exemplary non-transitory computer-readable storage medium stores instructions that, when executed by one or more processors of an electronic device, cause the device to: receive a first message from a first router of a plurality of routers comprising a first algorithm identifier associated with a first link cost computation algorithm and a first set of local condition data corresponding to the first router; compute, based on the first set of local condition data, a first set of link costs using the first link cost computation algorithm; compute, based on the first set of link costs, a first set of loop-free paths through the communication network; and route at least one communication according to the first set of loop-free paths.

In some embodiments, any of the features of any of the embodiments described above and/or described elsewhere herein may be combined, in whole or in part, with one another.

Additional advantages will be readily apparent to those skilled in the art from the following detailed description. The aspects and descriptions herein are to be regarded as illustrative in nature and not restrictive.

### BRIEF DESCRIPTION OF THE DRAWINGS

A better understanding of the features and advantages of the present disclosure will be obtained by reference to the following detailed description that sets forth illustrative embodiments, in which the principles of the disclosure are utilized, and the accompanying drawings of which:

FIG. 1 illustrates a conventional centralized traffic engineering architecture.

FIG. 2 illustrates an exemplary distributed traffic engineering architecture, according to some embodiments.

FIG. 3 illustrates exemplary functions of a router in a distributed traffic engineering architecture, according to some embodiments.

FIG. 4 illustrates an exemplary method for distributed traffic engineering in a communication network, according to some embodiments.

FIG. 5 illustrates an exemplary computing system, according to some embodiments.

### DETAILED DESCRIPTION

Described herein are examples of systems and methods for distributed traffic engineering in a communication network in which link costs are determined by individual routers in a distributed manner. A router of the communication network may be configured to receive messages from other routers of the network that enable the router to determine link costs, which the router may then use to determine loop-free paths through the network. A given message may include an algorithm identifier associated with a link cost computation algorithm for computing link costs (e.g., the prioritized Dynamic Routing Control Agent (pDRCA) algorithm) and a set of local condition data associated with the condition of the router from which the message was received. The set of local condition data may include, for example, the amount of traffic transiting the router and/or the source and destination IP addresses of the traffic transiting the router. Based on the set of local condition data provided in the received message, the router may use the link cost computation algorithm associated with the algorithm identifier in the message to compute a set of link costs for various links in the communication network. Alternatively, or additionally, the message may include one or more machine learning models configured to predict link costs without local condition data, and the one or more machine learning models may be used to predict a set of link costs for the communication network. Based on the link costs, a path computation algorithm (e.g., a shortest path algorithm or a minimum spanning tree algorithm) may be used to calculate a set of loop-free paths through the communication network.

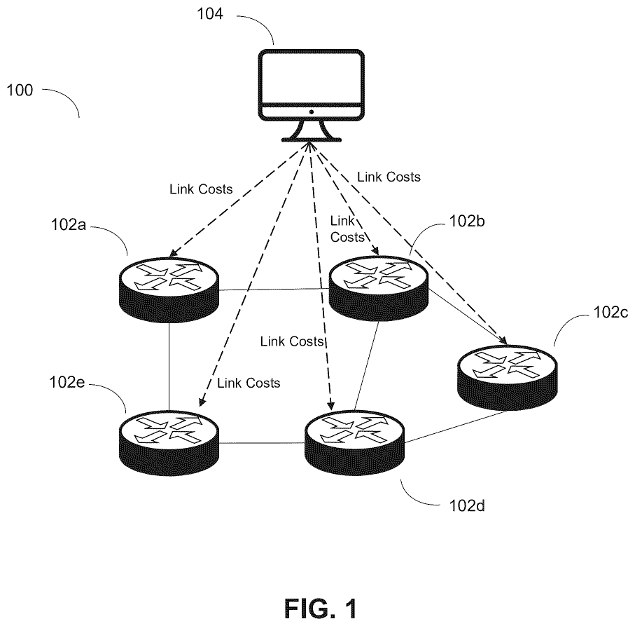

The systems and methods described herein offer several improvements over conventional techniques for routing communications in a network. Conventional traffic engineering architectures include a centralized controller for calculating link costs in a communication network. The centralized controller distributes those link costs to each router in the communication network to enable the routers to compute loop-free paths through the network. FIG. 1 illustrates an example of a conventional centralized traffic engineering architecture over which the present disclosure is an improvement. A centralized communication network 100 includes a plurality of routers 102a-e and a centralized controller 104. Each router of the plurality of routers 102a-e is communicatively coupled to at least one other router of the plurality of routers.

Centralized controller 104 is directly or indirectly communicatively coupled to the plurality of routers 102a-c. One or more link cost computation algorithms and/or one or more path computation algorithms are implemented on centralized controller 104. Using the algorithms, centralized controller 104 calculates link costs and/or loop-free paths for the entire communication network. Centralized controller 104 then communicates the link costs and/or loop-free paths to the plurality of routers 102a-c.

To calculate link costs, centralized controller 104 must receive local condition information (e.g., information about the traffic transiting a router) from each router 102a-e in communication network 100. Based on the local condition information received from the routers, centralized controller 104 may compute link costs for the entire communication network. Centralized controller 104 may then transmit the computed link costs to each router 102a-c in the communication network. Using the link costs, the routers 102a-e may independently compute loop-free paths, which may be used to route communications through the communication network. This centralized traffic engineering arrangement results in increased system latency. Because centralized controller 104 calculates link costs for the entire communication network, centralized controller 104 must send a message conveying the link costs to each individual router 102a-e so that the individual routers can compute loop-free paths, which may result in a large volume of messages. The large volume of messages may consume a large amount of bandwidth, which can introduce system delays, jitter, or dropped packets. Furthermore, because centralized controller 104 requires local condition information for each router in order to compute link costs and/or paths through the communication network, centralized controller 104 receives a large amount of local data. Sharing extensive amounts of local router data with centralized controller 104 may create privacy concerns.

The techniques described herein may provide several technical advantages over the conventional systems and methods described. As described above, the conventional approach of calculating paths and/or link costs at a centralized controller and distributing the calculated information to each router in the communication network can generate a large amount of network traffic and worsen latency of the network. The systems and methods described herein employ a distributed and decentralized approach for calculating link costs and loop-free paths in which link costs and loop-free paths are calculated at individual routers, thereby eliminating the need to transmit link costs and/or loop-free paths from a centralized controller to the various routers in the network.

According to some aspects, the systems and methods described herein improve latency and save bandwidth by incorporating the local condition information required for each router to calculate link costs into existing messaging exchanged between routers. As described, in order for an individual router to calculate link costs for other routers in the communication network, the individual router must receive local condition data about the other routers. As a result, distributed systems have, to date, been impractical because sending local condition data between routers requires too much bandwidth. The techniques described herein reduce the amount of bandwidth required by eliminating the need for separate cost signaling and incorporating the local condition information required for an individual router to calculate link costs into existing messaging.

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMS, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

As described, conventional centralized communication networks may experience low bandwidth and high latency due to the large volume of messages exchanged between the central controller and the routers in the network. To overcome these issues, a distributed traffic engineering architecture may be used in which a centralized controller is no longer required. In some embodiments, a centralized controller may still be included, but its role may be reduced in order to reduce network traffic and system latency.

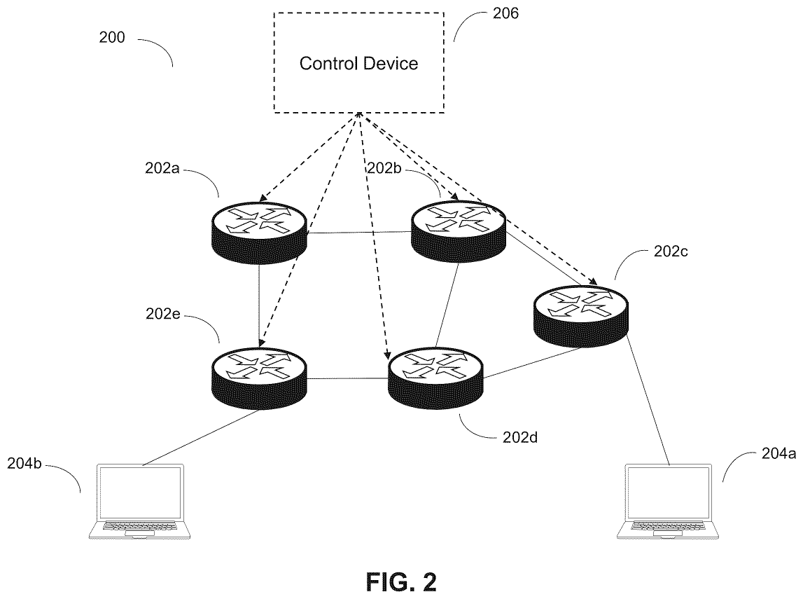

FIG. 2 illustrates aspects of an exemplary network 200 implementing a distributed and decentralized traffic engineering routing architecture, according to the principles described herein. As explained further below, a plurality of routers 202a-e of network 200 may compute link costs on their own instead of receiving link costs from a centralized controller. Although five routers 202a-e are shown in FIG. 2, one of ordinary skill in the art would appreciate that any number of routers can be used.

The plurality of routers 202a-e may be wired routers, wireless routers, edge routers, core routers, physical routers, virtual routers, or any combination thereof. Each router may be communicatively coupled to one or more other routers, such that each router can transmit information to and/or receive information from one or more other routers in the communication network. For example, as shown in FIG. 2, router 202a is communicatively coupled to routers 202b and 202e, each of which is communicatively coupled to additional routers.

In some embodiments, one or more of routers 202a-e may be communicatively coupled to one or more edge devices 204a-b. Edge devices 204a-b may include one or more information sources and/or sinks, such as computers, tablets, smartphones, or a combination thereof. In some embodiments, one or more of routers 202a-e may be configured to receive a communication from a first edge device (e.g., edge device 204a) and route the communication through the communication network 200 to a second edge device (e.g., edge device 204b). Although two edge devices are shown in FIG. 2, one of ordinary skill in the art would appreciate that any number of edge devices may be included.

In some embodiments, one or more of routers 202a-e may optionally be communicatively coupled to a control device 206. Control device 206 may be included for purposes other than communicating link costs and/or loop-free paths. For example, control device 206 may perform periodic control functions for routers 202a-e, such as updating the link cost computation algorithm used by the routers.

In some embodiments, routers 202a-e may exchange messages with one another. As described above, routers 202a-e may be configured to compute link costs for links in the network. To compute link costs, a router may need information about the local conditions at the other routers in the network. Accordingly, routers 202a-e may send and receive messages amongst themselves which include local condition information. Local condition information for a given router may include, but is not limited to, the amount or rate of traffic transiting the router, the source and destination IP addresses of the traffic transiting the router, the capabilities of the router (e.g., the identities of any link cost computation algorithms and/or path computation algorithms supported by the router), the identities of other routers to which the router is connected, and/or additional information about the router's connections to other routers (e.g., the bandwidth of an interface between routers).

In some embodiments, each router 202a-e may be configured to provide its own local condition information to one or more other routers in the communication network. In some embodiments, each router may provide its own local condition information to each other router to which it is directly connected (e.g., via a one-step link). For example, router 202a may send a message to routers 202b and 202e (to which router 202a is directly connected) which includes local condition information corresponding to router 202a.

In some embodiments, a given router may send an additional, separate message to each other router to which it is directly connected that includes local condition information that was received by the given router from a different router. For example, because router 202a is directly connected to router 202e, router 202a may receive a message including local condition information from router 202e. Thus, in addition to sending a first message to router 202b with its own local condition information, router 202a may send a second message to router 202b which includes local condition information corresponding to router 202e, since router 202a is connected to router 202e but router 202b is not. This may enable routers in the network to receive local condition information about other routers to which they are not directly connected.

In some embodiments, a given router may send a single message to each other router to which it is directly connected that includes its own local condition information as well as local condition information corresponding to one or more other routers. The one or more other routers may be routers to which the given router is directly connected but the router to which the message is sent is not. For example, router 202a may send a message to router 202b which includes local condition for both router 202a and router 202e, since router 202a may receive local condition information directly from router 202e but router 202b may not.

In some embodiments, routers 202a-e may be configured to exchange local condition information at a regular interval. In some embodiments, a router may be configured to send its own local condition information to other routers in the network when it transmits a communication that it has received (e.g., from another router or from an edge device, such as a computer, smartphone, tablet, or the like).

In some embodiments, a given router may automatically forward local condition information corresponding to other routers each time the router receives a message. For example, router 202a may automatically relay each message received from router 202e to router 202b. In other embodiments, a given router may include an internal algorithm which determines whether to relay received messages to other routers. For example, router 202a may include an internal algorithm which determines whether to relay messages received from router 202e to router 202b. The internal algorithm may be configured to only relay received messages if the information in a message is new (e.g., if the information has not been received by router 202a previously). New information may be relayed to other routers immediately, if possible. In some embodiments, new information may be sent on a time delay in order to prevent a given router from sending messages exceeding a pre-determined threshold number to a neighboring router within a specified time period.

In some embodiments, local condition information may be exchanged by encoding the information into existing messaging. In some embodiments, routers may already send messages to one another regarding aspects of routing other than local condition information. For example, routers may exchange information regarding independent path computation, such as the identity of a path computation algorithm to be used and link metrics used by the algorithm. Exemplary messaging for independent path computation is described in RFC 9502, which is a Request for Comments (RFC) that has been adopted by the Internet Engineering Task Force as an Internet Standard. According to RFC 9502, messaging regarding independent path computation may include the identity of a specific algorithm for computing loop-free paths and an algorithm-specific metric value, among other information. In a conventional scenario in which a central controller calculates link costs for the routers, as described above with respect to FIG. 1, each individual router encodes its link costs (received from the central controller) in the metric value field when the router propagates its link cost information within the network. However, when link costs are computed by individual routers, according to the principles described herein, link costs of each router may no longer be necessary to include in the messaging. Accordingly, in some embodiments, the local condition information can be encoded into existing RFC 9502 messaging instead of link costs. Because the metric value field no longer needs to encode link costs, the metric value field can be repurposed to accommodate other information, such as local condition information about the router from which the message originates and/or local condition information about other routers in the network. Encoding local condition information into existing messaging may reduce the amount of messaging required in a distributed traffic engineering architecture as compared to a centralized traffic engineering architecture. By taking advantage of existing messaging to encode additional information, the systems and methods described herein may reduce the amount of messaging required and improve latency of the system.

In some embodiments, the local condition information may be compressed or abbreviated to reduce the bandwidth required to transmit the information. In some embodiments, routers 202a-e may encrypt local condition information before transmitting the information to other routers. This is because exchanging local condition information between routers may create privacy concerns, since data about the routers is being shared throughout the communication network. For example, if detailed information about the local conditions at a router is intercepted by a bad actor, the actor may use that information to interfere with the router's connections, install malware on the router, redirect traffic through the network, or use the router to detect and attack other devices on the network.

In some embodiments, routers 202a-e may learn how to predict link costs using one or more machine learning models, which may reduce or eliminate the need for routers to share local condition information. Reducing or eliminating the amount of local condition information transmitted between routers and/or the frequency of transmitting local condition information between routers may alleviate privacy concerns. Furthermore, because many links in a network are bandwidth-limited, reducing the need to send local condition information may have the added benefit of improving bandwidth availability in a network.

In some embodiments, one or more machine learning models for predicting link costs may be trained using federated learning. Federated learning is a subset of machine learning in which a model is trained across distributed devices rather than at a central location with data from the various devices. The model may be trained locally on each device in order to protect the privacy of the training data. In some embodiments, federated learning involves providing local copies of a model to the devices in a distributed system. The devices may individually train their respective copies of the model using data from the respective devices. For example, a given router in a communication network may train a copy of a machine learning model to calculate link costs based on its own local condition information (e.g., by classifying links and mapping the classifications to link metrics). Once the routers in the communication network have sufficiently trained their respective copies of the model, the routers may share their respective copies of the model with a device within the communication network that is configured to consolidate the models from the routers into a single consolidated model. The device may be a given router within the communication network (e.g., a “master” router) or may be a central controller. The device may then share the consolidated model (or parameters thereof) with the routers in the communication network. The routers can use the consolidated model or model parameters to predict link costs for the network without requiring any or all of the actual local condition information from the routers in the network, thereby reducing or eliminating the need for routers to send local condition information to one another.

Alternatively, one or more machine learning models for predicting link costs may be trained using gossip learning. As in federated learning, local copies of a given machine learning model may be trained by the devices in a distributed system using data from the respective devices. For example, a given router in a communication network may train a local copy of a machine learning model to calculate link costs based on its own local condition information. However, instead of a router providing its trained copy of the model to a “master” router or central controller, the router may share its copy of the model (or parameters related to its copy of the model) with the cooperating routers in the network. The routers in the network may use the models or model parameters received from cooperating routers to compute link costs.

In some embodiments, link costs may be computed using a link cost computation algorithm other than a locally trained machine learning model. In some embodiments, messages exchanged by routers 202a-e may include an algorithm identifier associated with a link cost computation algorithm and/or a path computation algorithm. An algorithm identifier may correspond to a particular algorithm or combination of algorithms included in a registry of algorithms. The registry may be local to each router or may be accessed remotely (e.g., via the cloud). The registry may include a list of link cost computation algorithms, path computation algorithms, and/or combinations of link cost computation algorithms and path cost computation algorithms. Each entry on the registry may be assigned an algorithm identifier. In some embodiments, each message exchanged by routers 202a-e may include an algorithm identifier corresponding to an entry on the registry. The algorithm identifier included in the message may signal to the receiving router which algorithm or algorithms to use for link cost computation and/or path computation.

In some embodiments, when a router receives a message including an algorithm identifier, the router may access the registry to determine which algorithms are associated with the algorithm identifier. The router may access the registry locally or remotely. The received algorithm identifier may be associated with a link cost computation algorithm, a path computation algorithm, or both a link cost computation algorithm and a path computation algorithm.

In some embodiments, the received algorithm identifier is associated with a link cost computation algorithm. A link cost computation algorithm may be used to compute link costs in the communication network. In some embodiments, the link cost computation algorithm associated with the received algorithm identifier may be stored in a memory of one or more of routers 202a-e or in a memory of each router 202a-e. Using the link cost computation algorithm, the routers 202a-e may independently compute link costs for some or all of the communication network. Link costs may describe the “cost” or desirability of links between two connected nodes (e.g., routers) in a network. The total link cost for a given path through the network between any two routers may be equal to the sum of the link costs for each link along the path between the routers. For example, the total link cost of an exemplary path between router 202a and router 202c may be equal to the sum of the link cost for the path from router 202a to router 202b and the link cost for the path from router 202b to router 202c. In general, a lower link cost typically indicates a more desirable path. In some embodiments, the link cost computation algorithm may be the prioritized Dynamic Routing Control Agent (pDRCA) algorithm. Other examples of link cost computation algorithms include link weight algorithms embodied in Open Shortest Path First (OSPF) or Intermediate System to Intermediate System (IS-IS) algorithms, or Multi-Agent Reinforcement Learning (MARL) algorithms.

In some embodiments, a given router may compute link costs for at least a portion of the network 200. In some embodiments, a given router may compute link costs for the entire communication network 200 for which the router determines paths and maintains a routing table (e.g., for a single local network or for multiple interconnected local networks).

In some embodiments, multiple link cost computation algorithms may be stored in a memory of the plurality of routers 202a-e, and the routers may be configured to switch from one link cost computation algorithm to another depending on the link cost computation algorithm associated with the algorithm identifier included in the message from another router. Switching the link cost computation algorithm used by routers 202a-e may require a user to configure the routers manually (e.g., by disabling one link cost computation algorithm and enabling another link cost computation algorithm). In some embodiments, the local condition information required to calculate link costs may vary based on the requirements of the link cost computation algorithm being used.

In some embodiments, the algorithm identifier included in the messages exchanged by routers 202a-e may also be associated with a path computation algorithm for computing loop-free paths through the network. In some embodiments, the path computation algorithm associated with the received algorithm identifier may be stored in a memory of each router 202a-c. In some embodiments, the path computation algorithm may be a shortest path algorithm (e.g., the Constrained Shortest Path First (CSPF) algorithm, the Open Shortest Path First (OSPF) algorithm, Dijkstra's Shortest Path algorithm, or the Bellman-Ford Shortest Path algorithm), a minimum spanning tree algorithm (e.g., Kruskal's Minimum Spanning Tree or Prim's Minimum Spanning Tree), or any other suitable algorithm for computing loop-free paths. Shortest path algorithms calculate the shortest path between two given routers in the communication network. Different path computation algorithms may be used in order to optimize different parameters (e.g., latency, monetary cost, or avoidance of a particular router), which may be specified by a user. In some embodiments, routers 202a-e may be configured to use the path computation algorithm associated with the algorithm identifier included in the messages received from the other routers. In some embodiments, multiple path computation algorithms may be implemented on routers 202a-e, and the routers may be configured to switch from one path computation algorithm to another. Switching the path computation algorithm used by routers 202a-e may require a user to manually configure the routers accordingly (e.g., by disabling one path computation algorithm and enabling another path computation algorithm).

In some embodiments, the paths computed by routers 202a-e are loop-free paths. A loop-free path from a source router to a destination router is a path which does not forward traffic back through a previously traversed router to reach the destination. For example, if a path is traced from a source router to a destination router, the path is loop-free if it reaches the destination router without crossing a router twice. Using loop-free paths to route traffic in a communication network may avoid the issue of looping traffic, in which messages do not reach their destination or are heavily delayed in reaching their destination because network traffic loops on itself (e.g., by bouncing back and forth between the same set of routers). Looping traffic can cause congestion and worsen latency of the network.

In some embodiments, the loop-free paths calculated by a router may be used to populate or update the routing table for the respective router. A routing table is a record of the next hop routers that a router can use to get to various destinations in the network. The loop-free path traversed by a given communication includes a chain of next hop routers designated by each router traversed by the communication. The routing table may also include metrics associated with the next hop routers in order to aid the router in determining which next hop router(s) to use to pass a communication through the network. In some embodiments, routers 202a-e may route communications through the network according to the loop-free paths and corresponding metrics in their routing tables. For example, router 202e may receive a communication from edge device 204b which is intended for edge device 204a. Based on the loop-free paths and corresponding metrics in its routing table, router 202e may route the communication through one or more routers in network 200 (e.g., routers 202d and 202c) to reach edge device 204a.

In some embodiments, messages exchanged between routers may include more than one algorithm identifier. Different algorithm identifiers may correspond to different types of data. For example, if data to be routed through a network comprises both real-time data (e.g., audio and/or video from a video conference) and non-real-time data (e.g., a downloadable file or buffered streaming data), routers may exchange messages that include a first algorithm identifier that identifies a link cost computation algorithm and/or a path computation algorithm to use to route the real-time data and a second algorithm identifier that identifies a link cost computation algorithm and/or a path computation algorithm to use to route the non-real-time data. In some embodiments, the algorithm identifiers may be included in the same message or may be sent in separate messages.

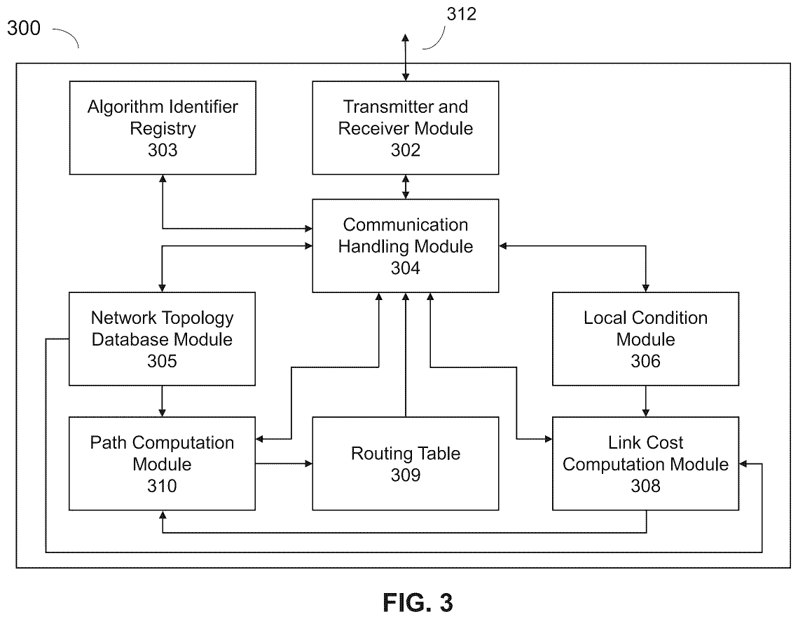

As described, routers in a communication network may be configured to receive messages from other routers containing local condition information and algorithm identifiers associated with algorithms to use for computing link costs and paths through the network, compute link costs, compute paths through the network, and transmit messages to other routers so that they can do the same. FIG. 3 illustrates a functional block diagram of a router 300 configured to perform these tasks, according to some embodiments. Router 300 can be used for any of the routers 202a-e of FIG. 2.

A router 300 may be a wired router, wireless router, edge router, core router, physical router, or virtual router. The modules of router 300 shown in the functional block diagram of FIG. 3 represent functions of the router and may be implemented in the same or separate hardware, software, or a combination thereof. Router 300 may be one of multiple routers in a communication network, such as an internet protocol computer network.

Router 300 may include a transmitter and receiver module 302. Transmitter and receiver module 302 may be configured to transmit messages to and receive messages from external sources, such as other routers or edge devices (e.g., computers, smartphones, tablets, etc.) in the network, via one or more communication connections 312 (e.g., wireless connections, copper cable connections, fiberoptic cable connections, etc.). For example, in a network, such as that illustrated in FIG. 2, the transmitter and receiver module 302 of a router may receive messages from other routers in the network regarding local condition information, algorithm identifiers corresponding to link cost computation and path computation algorithms, and/or machine learning models configured for computing link costs. Transmitter and receiver module 302 may also transmit local condition information about the router to other routers in the network. Transmitter and receiver module 302 may route outgoing messages according to a routing table 309, which may be populated with loop-free paths computed by a path computation module 310.

Router 300 may further include a communication handling module 304. Communication handling module 304 may manage all communications received and transmitted by router 300. For example, communication handling module 304 may process information received by transmitter and receiver module 302 and distribute the information to the appropriate module. As described above, transmitter and receiver module 302 may receive messages from other routers in the communication network including local condition information about the other routers, algorithm identifiers associated with link cost computation and/or path computation algorithms, and/or machine learning models configured for computing link costs. Communication handling module 304 may determine where to distribute the information contained in an incoming message. For instance, communication handling module 304 may provide the local condition information from the incoming message to a link cost computation module 308. Communication handling module 304 may also access an algorithm identifier registry 303 to determine a link cost computation algorithm and/or a path computation algorithm associated with an algorithm identifier in the received message. Communication handling module 304 may then provide the identities of the algorithms to link cost computation module 308 and path computation module 310.

Communication handling module 304 may also prepare outbound messages to be transmitted outside of router 300 by transmitter and receiver module 302. For instance, communication handling module 304 may encode local condition information received from local condition module 306, local condition information received from other routers in the network, the identity of a link cost computation algorithm from link cost computation module 308, the identity of a path computation algorithm from path computation module 310, and/or information about how router 300 is connected to other routers in the network from network topology database module 305 into one or more messages to be provided to other routers in the communication network by transmitter and receiver module 302.

Communication handling module 304 may also instruct transmitter and receiver module 302 how to route prepared outbound messages. Communication handling module 304 may receive information about how to route a communication through the network from routing table 309, which may contain the loop-free paths through the network computed by path computation module 310. Communication handling module 304 may relay the paths provided by routing table 309 to transmitter and receiver module 302 so that transmitter and receiver module 302 can route the one or more messages through the network accordingly.

Local condition module 306 may determine local conditions at the router 300. The local conditions determined by local condition module 306 may include the amount or rate of traffic transiting the router and the source and destination IP addresses of the traffic transiting the router. Local condition module 306 may provide the local conditions to communication handling module 304 so that communication handling module 304 can encode the local condition information into one or more messages to be transmitted to other routers. Local condition module 306 may also provide the local conditions to link cost computation module 308, which may use the local conditions to compute link costs.

Link cost computation module 308 may compute link costs for links in the communication network. As described above with reference to FIGS. 1 and 2, link costs are arbitrary values that indicate the desirability of next hop routers when forwarding communications in the communication network. In general, given two different paths from a source router to a destination router, the path comprising a set of links for which the sum of the link costs is lower is the more desirable or more efficient path. Link cost computation module 308 may compute link costs using a link cost computation algorithm, such as pDRCA. The link cost computation algorithm used to compute link costs may be a link cost computation algorithm associated with an algorithm identifier provided in a received message and communicated to link cost computation module 308 by communication handling module 304. The link cost computation algorithm may use the local condition information from local condition module 306 and from other routers in the communication network to compute link costs. The link cost computation algorithm may also use information received from network topology database module 305, which provides information to link cost computation module 308 about how the routers in the network are connected to one another. Alternatively, or additionally, link cost computation module 308 may include one or more machine learning models configured to predict link costs that were trained via federated learning or gossip learning, as described above with reference to FIG. 2. Link cost computation module 308 may then provide the link costs computed by the link cost computation algorithm and/or the one or more machine learning models to path computation module 310.

Path computation module 310 may use the link costs computed by link cost computation module 308 to compute loop-free paths through the communication network. The path computation algorithm may also use information received from network topology database module 305, which provides information to path computation module 310 about how the routers in the network are connected to one another. The loop-free paths may be used to populate a routing table 309 for router 300, which may be used to route messages through the communication network. Path computation module 310 may compute loop-free paths using a path computation algorithm, such as a shortest path algorithm (e.g., OSPF, CSPF, Dijkstra's Shortest Path, or Bellman-Ford Shortest Path). The path computation algorithm used to compute the loop-free paths may be a path computation algorithm associated with an algorithm identifier provided in a received message and communicated to path computation module 310 by communication handling module 304.

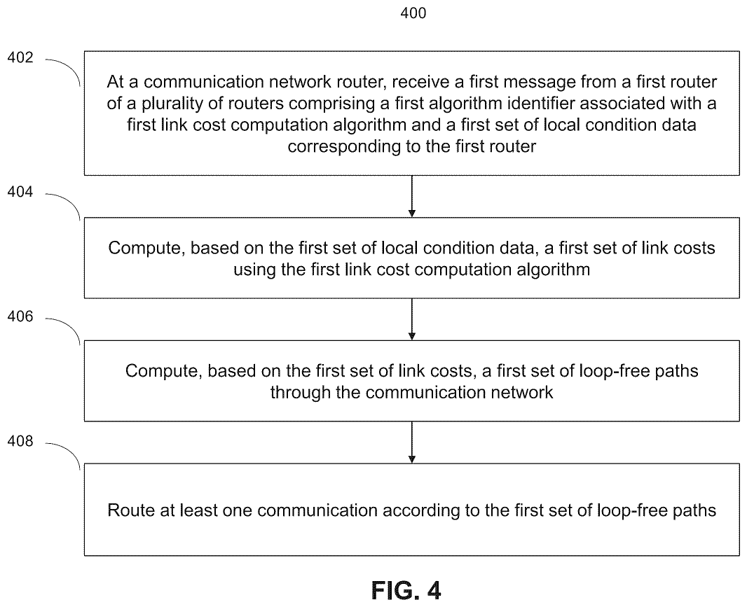

FIG. 4 illustrates an exemplary method 400 for distributed traffic engineering in a communication network, according to some embodiments. Method 400 may be performed by one or more of routers 202a-e of FIG. 2 and/or router 300 of FIG. 3. In some embodiments, some steps of method 400 may be, optionally, combined; the order of some steps may be, optionally, changed; and some steps may be, optionally, omitted. In some embodiments, additional steps may be performed in combination with the method 400. Accordingly, the operations illustrated (and described in greater detail below) are exemplary by nature and, as such, should not be viewed as limiting.

Step 402 includes, at a given router, receiving a first message from a first router of a plurality of routers comprising a first algorithm identifier associated with a first link cost computation algorithm and a first set of local condition data corresponding to first router. In some embodiments, the first message may be received by a transmitter and receiver module 302 of the communication network router, as described above with reference to FIG. 3. In some embodiments, the given router and the first router may be part of a communication network including a plurality of routers, such as network 200 described above with reference to FIG. 2. For example, router 202a may receive a message from router 202b that may include an algorithm identifier and a set of local conditions for router 202b.

The first algorithm identifier included in the first message may correspond to an entry on a registry of algorithms. The registry may include a list of algorithm identifiers associated with various algorithms and/or combinations of algorithms. For example, the registry may include a list of algorithm identifiers associated with link cost computation algorithms, path computation algorithms, and/or combinations of link cost computation algorithms and path computation algorithms. The registry may be local to the router or may be accessed remotely (e.g., via the cloud).

The first link cost computation algorithm associated with the first algorithm identifier may be, for example, pDRCA, a link weight algorithm embodied in an OSPF or IS-IS routing protocol, or a MARL algorithm. In some embodiments, the first link cost computation algorithm associated with the first algorithm identifier may be an algorithm stored in a memory of the router.

The first set of local condition data may include a summary of the traffic transiting the first router from which the first message was received. For instance, the first set of local condition data may include an amount or rate of traffic transiting the first router, the source IP addresses of the traffic, and/or the destination IP addresses of the traffic. In some embodiments, additional local information may be included in the first set of local condition data based on the inputs required for the first link cost computation algorithm.

In some embodiments, the first message may further include local condition data about other routers in the network to which the communication network router is not directly connected. For example, in FIG. 2, router 202a may receive a message from router 202b that may include the first set of local condition data about router 202b as well as local condition data about routers 202c and 202d, to which router 202b is connected but router 202a is not. In some embodiments, receiving local condition data about other routers to which router 202a is not directly connected may enable router 202a to calculate link costs across some or all of network 200 despite not being connected to each node in the network. In some embodiments, the first message may include local condition data only for the first router.

In some embodiments, the first set of local condition data may be compressed or abbreviated to reduce the amount of bandwidth required to transmit the first message. In some embodiments, the first set of local condition data may be encrypted to protect the privacy of the first router.

In some embodiments, the first algorithm identifier included in the first message may also be associated with a path computation algorithm. The path computation algorithm may be, for example, a shortest path algorithm such as the CSPF algorithm, OSPF algorithm, Dijkstra's Shortest Path algorithm, or Bellman-Ford Shortest Path algorithm. In some embodiments, the path computation algorithm associated with the first algorithm identifier included in the first message may be configured to optimize one or more parameters of the network. For example, a path computation algorithm may optimize latency or monetary cost or may be configured to avoid a certain router (e.g., a router which is not functioning properly).

In some embodiments, the first message may include one or more machine learning models or parameters thereof. The one or more machine learning models may be configured to compute link costs. The one or more machine learning models may be trained to compute link costs using federated learning and/or gossip learning, as described above with reference to FIG. 2. In some embodiments, the one or more machine learning models may be configured to compute link costs without any or all of the local condition information corresponding to the router from which the first message was received. Consequently, the first message may include only local models and/or parameters thereof, and not local condition information.

In some embodiments, the first message may be part of existing messaging exchanged between the first router and the communication network router which is exchanged for a reason other than providing the communication network router with local condition information and/or an algorithm identifier associated with a link cost computation algorithm. For example, routers in a communication network may already send messages to one another regarding independent path computation, such as the identity of a path computation algorithm to be used and link metrics used by the algorithm. Messaging for independent path computation may be sent according to the protocol described in RFC 9502, as described above with reference to FIG. 2. In RFC 9502, messaging regarding independent path computation may include the identity of a specific algorithm for computing loop-free paths and an algorithm-specific metric value. If link costs are computed by individual routers, the metric value may no longer be necessary to include in the messaging, and local condition information and/or an algorithm identifier can be encoded into existing RFC 9502 messaging instead.

In some embodiments, step 402 may be repeated for one or more routers in a communication network. If the communication network router is connected to more than one router, the communication network router may receive messages from each of the connected routers or from a subset thereof. For example, in FIG. 2, router 202a is communicatively coupled to both routers 202b and 202e and may therefore receive messages from routers 202b and 202e. As described above, the messages received from routers 202b and 202e may include information about other routers to which routers 202b and 202e are connected but router 202a is not, which may enable router 202a to receive local condition information and compute link costs for the whole network rather than just for the routers to which router 202a is connected. In some embodiments, similar messages to those received by router 202a may be received by each other router 202b-e in the network, such that each router 202a-e may compute link costs for the whole network.

Step 404 includes computing, based on the first set of local condition data, a first set of link costs using the first link cost computation algorithm. The first set of link costs may be computed by a link cost computation module 308 described above with reference to FIG. 3. In some embodiments, the first link cost computation algorithm may be used to compute link costs using the first set of local condition data received from the first router. The first link cost computation algorithm may also use local conditions at one or more other routers in the network and at the communication network router which received the message. The first link cost computation algorithm used to compute the first set of link costs may be the link cost computation algorithm associated with the algorithm identifier indicated in the first message received at step 402. In some embodiments, the algorithm identifiers identify one or more machine learning models trained via federated learning or gossip learning that may be used to predict the first set of link costs.

Step 406 includes computing, based on the first set of link costs, a first set of loop-free paths through the communication network. The first set of loop-free paths may be computed by a path computation module 310 described above with reference to FIG. 3. In some embodiments, the first set of loop-free paths may be used to populate or update a routing table of the communication network router, which the communication network router may use to determine how to route communications through the network.

In some embodiments, a path computation algorithm may be used to compute the first set of loop-free paths. In some embodiments, if the first algorithm identifier included in the first message is associated with a path computation algorithm, the path computation algorithm used to compute the first set of loop-free paths may be the algorithm associated with the first algorithm identifier. The path computation algorithm may be a shortest path algorithm (e.g., the OSPF algorithm, the CSPF algorithm, Dijkstra's Shortest Path algorithm, or the Bellman-Ford Shortest Path algorithm) or any other suitable path computation algorithm.

In some embodiments, more than one path computation algorithm may be stored in a memory of a given router. The path computation algorithm used to compute loop-free paths may be selected based on a desired optimization parameter. For instance, a path computation algorithm may be configured to optimize latency or monetary cost or to avoid using a certain router or link. As described above with reference to step 402, an algorithm identifier associated with the path computation algorithm to be used may be specified in the messages exchanged between routers. In some embodiments, switching from one path computation algorithm to another may require a user to manually configure the communication network router accordingly.

Step 408 includes routing at least one communication according to the first set of loop-free paths. Routing at least one communication according to the first set of loop-free paths may be performed by a transmitter and receiver module 302 described above with reference to FIG. 3. In some embodiments, routing at least one communication according to the first set of loop free paths may include receiving a communication from an edge device. The edge device may be an information source such as a computer, tablet, smartphone, or other device connected to one or more routers in the network. The communication from the edge device may be received by one or more routers in the network. For example, in FIG. 2, router 202e may receive a communication from edge device 204b. The communication may be intended for edge device 204a. Based on the set of loop-free paths calculated by router 202e, router 202e may route the communication through network 200 via one or more of the other routers 202a-d.

As described above, routing the communication according to the first set of loop-free paths may ensure that the communication is transmitted to its destination without getting caught in a traffic “loop” in which the communication is exchanged between routers in an inefficient, circular manner. Using FIG. 2 as an example, there are multiple pathways to route a communication from edge device 204b to edge device 204a. Edge device 204b may provide a communication to router 202e. Three exemplary paths are contemplated herein, although one of ordinary skill in the art will appreciate that any number of paths may exist between edge devices 204b and 204a.

Router 202e may receive the communication from edge device 204b. Using a first path, router 202e may route the communication to router 202d and then to router 202c, which can provide the communication to edge device 204a. Using a second path, router 202e may route the communication to router 202a, to router 202b, and then to router 202c, which can provide the communication to edge device 204a. Using a third path, router 202e may route the communication to router 202a, to router 202b, to router 202d, back to router 202c, to router 202a, to router 202b, and finally to router 202c. The first and second paths are loop-free paths, since they do not cross the same router twice. However, the third path is a looping path, since the third path crosses one or more routers more than once. In some embodiments, router 202e may be configured to route the communication via one of the loop-free paths (the first path or the second path) in order to eliminate the traffic loop of the third path and reduce the amount of unnecessary network traffic.

In some embodiments, router 202e may be configured to route the communication via the loop-free path which has the lowest total link cost and/or is the shortest path. The total link cost of the first path is the sum of the link costs of the link between routers 202c and 202d and the link between routers 202d and 202c. The total link cost of the second path is the sum of the link costs of the link between routers 202e and 202a, the link between routers 202a and 202b, and the link between routers 202b and 202c. In some embodiments, the total link cost of the first path may be lower because the first path has less links and is the shortest path. In some embodiments, the total link cost of the second path may be lower despite having more links if the costs of the links in the second path are cumulatively lower than the cost of the links in the first path (e.g., if the first path has high link costs due to heavy traffic along those links).

As described above with reference to FIG. 2, a memory of a given router may store more than one link cost computation algorithms. Accordingly, in some embodiments, the link cost computation algorithm used by a router to compute link costs for a network may be switched. In some embodiments, switching the link cost computation algorithm may require a user to manually configure the router to use a different link cost computation algorithm. In some embodiments, if the link cost computation algorithm is switched, steps 402-408 of method 400 may be repeated with respect to a second message that specifies a second algorithm identifier associated with a second, different link cost computation algorithm. For instance, the communication network router may receive a second message from the first router including a second algorithm identifier associated with a second link cost computation algorithm and a second (updated) set of local condition data corresponding to the first router. The communication network router may compute, based on the second set of local condition data, a second set of link costs using the second link cost computation algorithm. The communication network router may then compute, based on the second set of link costs, a second set of loop-free paths through the communication network. A communication may then be routed according to the second set of loop-free paths.

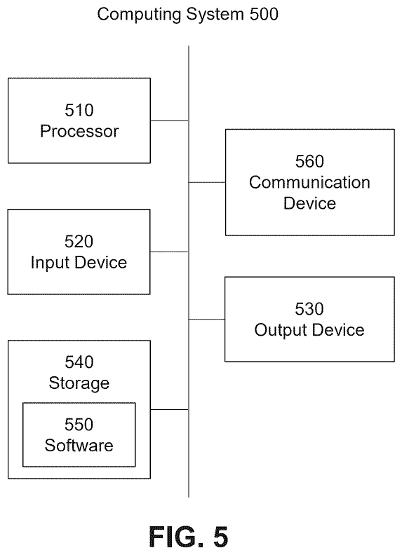

In one or more examples, the disclosed systems and methods utilize or may include a computing system. For example, the functional components described above with reference to FIG. 3 may run on a computing system. Furthermore, network 200 described above with reference to FIG. 2 may include one or more computing systems (e.g., routers 202a-c, edge devices 204a-b, and/or control device 206). FIG. 5 illustrates an exemplary computing system that can be used for any of the computing systems described herein for performing any of the functions described herein. Computing system 500 can be a host computer connected to a network. Computing system 500 can be a client computer or a server. As shown in FIG. 5, computing system 500 can be any suitable type of microprocessor-based device, such as a router, personal computer, workstation, server, specialized hardware device (e.g., an application-specific integrated circuit (ASIC)), or handheld computing device, such as a phone or tablet. The computing system can optionally include, for example, one or more of processor 510, input device 520, output device 530, storage 540, and communication device 560. Optionally, input device 520 and output device 530 can correspond to those described above and can either be connectable or integrated with the computing system. For example, input device 520 and/or output device 530 may be connected to computing system 500 via a wired or wireless connection (e.g., via a console cable connected to a console port of the computing system).

Input device 520 can be any suitable device that provides input, such as a touch screen or monitor, keyboard, mouse, or voice-recognition device. Output device 530 can be any suitable device that provides an output, such as a touch screen, monitor, printer, disk drive, or speaker.

Storage 540 can be any suitable device that provides storage, such as an electrical, magnetic, or optical memory, including a random-access memory (RAM), cache, hard drive, CD-ROM drive, tape drive, or removable storage disk. Communication device 560 can include any suitable device capable of transmitting and receiving signals over a network, such as a network interface chip or card. The components of the computing system can be connected in any suitable manner, such as via a physical bus or wirelessly. Storage 540 can be a non-transitory computer-readable storage medium comprising one or more programs, which, when executed by one or more processors, such as processor 510, cause the one or more processors to execute methods described herein (e.g., method 400 described above with reference to FIG. 4).

Software 550, which can be stored in storage 540 and executed by processor 510, can include, for example, the programming that embodies the functionality of the present disclosure (e.g., as embodied in the systems, routers, computers, servers, and/or devices as described above). For instance, software 550 may include one or more link cost computation algorithms and/or one or more path computation algorithms. In one or more examples, software 550 can include a combination of servers such as application servers and database servers.

Software 550 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 540, that can contain or store programming for use by or in connection with an instruction execution system, apparatus, or device.

Software 550 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computing system 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, fiber optic transmission links, T1 or T3 lines, cable networks, DSL, or telephone lines.

Computing system 500 can implement any operating system suitable for operating on the network. Software 550 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A communication network router comprising one or more processors and memory storing one or more programs for execution by the one or more processors, the one or more programs including instructions that cause the communication network router to:
receive a first message from a first router of a plurality of routers of a communication network, the first message comprising a first algorithm identifier associated with a first link cost computation algorithm and a first set of local condition data corresponding to the first router;
compute, based on the first set of local condition data, a first set of link costs using the first link cost computation algorithm;
compute, based on the first set of link costs, a first set of loop-free paths through the communication network; and
route at least one communication according to the first set of loop-free paths.

2. The communication network router of claim 1, wherein the first algorithm identifier is associated with a path computation algorithm.

3. The communication network router of claim 2, wherein the first set of loop-free paths are computed using the path computation algorithm.

4. The communication network router of claim 2, wherein the path computation algorithm is a shortest path algorithm or a minimum spanning tree algorithm.

5. The communication network router of claim 1, wherein the first message comprises at least a second set of local condition data corresponding to at least a second router.

6. The communication network router of claim 1, wherein the instructions cause the communication network router to update a routing table based on the first set of loop-free paths.

7. The communication network router of claim 1, wherein routing at least one communication according to the first set of loop-free paths comprises:
receiving the at least one communication from a first edge device;
determining, based on at least the first set of loop-free paths, a path through the communication network between the first edge device and a second edge device; and
transmitting the at least one communication along the determined path.

8. The communication network router of claim 1, wherein a second link cost computation algorithm is stored in the memory of the communication network router.

9. The communication network router of claim 8, wherein the communication network router is configured to:
receive a second message from the first router comprising a second algorithm identifier associated with the second link cost computation algorithm and a second set of local condition data corresponding to the first router;
compute, based on the second set of local condition data, a second set of link costs using the second link cost computation algorithm;
compute, based on the second set of link costs, a second set of loop-free paths through the communication network; and
route at least one communication according to the second set of loop-free paths.

10. The communication network router of claim 1, wherein the first link cost computation algorithm is prioritized Dynamic Routing Control Agent (pDRCA), a Multi-Agent Reinforcement Learning (MARL) algorithm, an Open Shortest Path First (OSPF) algorithm, or an Intermediate System to Intermediate System (IS-IS) algorithm.

11. The communication network router of claim 1, wherein the first set of local condition data corresponding to the first router comprises an amount of traffic transiting the first router and source and destination IP addresses of traffic transiting the first router.

12. The communication network router of claim 1, wherein the first set of local condition data comprises encrypted local condition data.

13. The communication network router of claim 1, wherein the first message comprises a locally-trained machine learning model or parameters of the locally-trained machine learning model, wherein the locally-trained machine learning model is configured to predict link costs.

14. The communication network router of claim 1, wherein the communication network router is a wired router, a wireless router, an edge router, a core router, a physical router, or a virtual router.

15. The communication network router of claim 1, wherein the first algorithm identifier corresponds to an entry in a registry comprising a plurality of algorithm identifiers, wherein each algorithm identifier of the plurality of algorithm identifiers is associated with at least one respective algorithm.

16. The communication network router of claim 15, wherein the registry is stored in a memory of the communication network router.

17. The communication network router of claim 15, wherein the registry is stored remotely and accessed by the communication network router.

18. A method for routing communications in a network, the method comprising:
at a communication network router:
receiving a first message from a first router of a plurality of routers comprising a first algorithm identifier associated with a first link cost computation algorithm and a first set of local condition data corresponding to the first router;
computing, based on the first set of local condition data, a first set of link costs using the first link cost computation algorithm;
computing, based on the first set of link costs, a first set of loop-free paths through the communication network; and
routing at least one communication according to the first set of loop-free paths.

19. The method of claim 18, wherein the first algorithm identifier is associated with a path computation algorithm.

20. The method of claim 19, wherein computing the first set of loop-free paths comprises applying the path computation algorithm.

21. The method of claim 19, wherein the path computation algorithm is a shortest path algorithm or a minimum spanning tree algorithm.

22. The method of claim 18, wherein the first message comprises at least a second set of local condition data corresponding to at least a second router.

23. The method of claim 18, comprising updating a routing table based on the first set of loop-free paths.

24. The method of claim 18, wherein routing at least one communication according to the first set of loop-free paths comprises:
receiving the at least one communication from a first edge device;
determining, based on at least the first set of loop-free paths, a path through the communication network between the first edge device and a second edge device; and
transmitting the at least one communication along the determined path.

25. The method of claim 18, wherein a second link cost computation algorithm is stored in a memory of the communication network router.

26. The method of claim 23, comprising:
receiving a second message from the first router comprising a second algorithm identifier associated with the second link cost computation algorithm and a second set of local condition data corresponding to the first router;
computing, based on the second set of local condition data, a second set of link costs using the second link cost computation algorithm;
computing, based on the second set of link costs, a second set of loop-free paths through the communication network; and
routing at least one communication according to the second set of loop-free paths.

27. The method of claim 18, wherein the first link cost computation algorithm is prioritized Dynamic Routing Control Agent (pDRCA), a Multi-Agent Reinforcement Learning (MARL) algorithm, an Open Shortest Path First (OSPF) algorithm, or an Intermediate System to Intermediate System (IS-IS) algorithm.

28. The method of claim 18, wherein the first set of local condition data corresponding to the first router comprises an amount of traffic transiting the first router and source and destination IP addresses of traffic transiting the first router.

29. The method of claim 18, wherein the first set of local condition data comprises encrypted local condition data.

30. The method of claim 18, wherein the first message comprises a locally-trained machine learning model or parameters of the locally-trained machine learning model, wherein the locally-trained machine learning model is configured to predict link costs.

31. The method of claim 18, wherein the communication network router is a wired router, a wireless router, an edge router, a core router, a physical router, or a virtual router.

32. The method of claim 18, wherein the first algorithm identifier corresponds to an entry in a registry comprising a plurality of algorithm identifiers, wherein each algorithm identifier of the plurality of algorithm identifiers is associated with at least one respective algorithm.

33. The method of claim 32, wherein the registry is stored in a memory of the communication network router.

34. The method of claim 32, wherein the registry is stored remotely and accessed by the communication network router.

35. A non-transitory computer-readable storage medium storing instructions that, when executed by one or more processors of an electronic device, cause the device to:
receive a first message from a first router of a plurality of routers comprising a first algorithm identifier associated with a first link cost computation algorithm and a first set of local condition data corresponding to the first router;
compute, based on the first set of local condition data, a first set of link costs using the first link cost computation algorithm;
compute, based on the first set of link costs, a first set of loop-free paths through the communication network; and
route at least one communication according to the first set of loop-free paths.
